(19) United States
(12) Patent Application Publication
(10) Pub. No.: US 2026/0356722 A1
(43) Pub. Date: Nov. 12, 2026

(54) APPARATUS AND METHOD FOR MANUFACTURING A GLASS ARTICLE

(71) Applicant: CORNING INCORPORATED, CORNING, NY (US)

(72) Inventors: Rashid Abdul-Rahman, Livermore, CA (US); JinSoo Kim, Asan (KR); Brian Michael Palmer, Corning, NY (US)

(21) Appl. No.: 19/120,874

(22) PCT Filed: Oct. 11, 2023
(86) PCT No.: PCT/US2023/034885

§ 371 Date: Apr. 14, 2025

Related U.S. Application Data
(60) Provisional application No. 63/419,122, filed on Oct. 25, 2022.

(51) Int. Cl. C03B 5/43; C03B 5/26; C03B 17/06

(52) U.S. Cl. CPC C03B 5/43; C03B 5/26; C03B 17/064

(57) ABSTRACT

An apparatus and method for manufacturing a glass article include a glass melting furnace in fluid communication with a connecting conduit, a first annular sealing element circumferentially surrounding the connecting conduit at an interface of the glass melting furnace and the connecting conduit, and an annular heating element circumferentially surrounding the connecting conduit and separated from the first annular sealing element by a predetermined distance along an axial length of the connecting conduit.

### CROSS-REFERENCE TO RELATED APPLICATIONS

This application claims the benefit of priority under 35 U.S.C. § 119 of U.S. Provisional Application Serial No. 63/419122 filed on Oct. 25, 2022, the content of which is relied upon and incorporated herein by reference in its entirety.

### FIELD

The present disclosure relates generally to apparatuses and methods for manufacturing glass articles, and more particularly to apparatuses and methods for manufacturing glass articles with improved molten glass delivery characteristics.

### BACKGROUND

In the production of glass articles, such as glass sheets for display applications, including televisions and hand held devices, such as telephones and tablets, molten material is typically transported through one or more conduits, such as conduits comprised of a precious metal, such as platinum. Such conduits can be directly heated, for example, by an electrically powered flange comprising a metallic material that circumferentially surrounds the conduit. During such heating, conduit corrosion can lead to a variety of undesirable consequences such as glass leaks, power flange failure, process downtime, and molten glass contamination.

### SUMMARY

Embodiments disclosed herein include an apparatus for manufacturing a glass article. The apparatus includes a glass melting furnace in fluid communication with a connecting conduit. The apparatus also includes a first annular sealing element circumferentially surrounding the connecting conduit at an interface of the glass melting furnace and the connecting conduit. In addition, the apparatus includes an annular heating element circumferentially surrounding the connecting conduit and separated from the first annular sealing element by a predetermined distance along an axial length of the connecting conduit.

Embodiments disclosed herein also include a method of manufacturing a glass article. The method includes flowing molten glass from a glass melting furnace to a connecting conduit, wherein a first annular sealing element circumferentially surrounds the connecting conduit at an interface of the glass melting furnace and the connecting conduit. The method also includes heating the connecting conduit with an annular heating element circumferentially surrounding the connecting conduit and separated from the first annular sealing element by a predetermined distance along an axial length of the connecting conduit.

Additional features and advantages of the embodiments disclosed herein will be set forth in the detailed description which follows, and in part will be readily apparent to those skilled in the art from that description or recognized by practicing the disclosed embodiments as described herein, including the detailed description which follows, the claims, as well as the appended drawings.

It is to be understood that both the foregoing general description and the following detailed description present embodiments intended to provide an overview or framework for understanding the nature and character of the claimed embodiments. The accompanying drawings are included to provide further understanding, and are incorporated into and constitute a part of this specification. The drawings illustrate various embodiments of the disclosure, and together with the description serve to explain the principles and operations thereof.

### BRIEF DESCRIPTION OF THE DRAWINGS

FIG. 1 is a schematic view of an example fusion down draw glass making apparatus and process;

FIG. 2 is a schematic perspective side view of a portion of a glass manufacturing apparatus including a conduit;

FIG. 3 is a schematic perspective side view of a portion of a glass manufacturing apparatus including a conduit in accordance with embodiments disclosed herein;

FIG. 4 is a schematic perspective cutaway view of an annular heating element circumferentially surrounding a portion of a conduit;

FIG. 5 is a schematic perspective cutaway view of an annular heating element circumferentially surrounding a portion of a conduit in accordance with embodiments disclosed herein;

FIG. 6 is a schematic perspective cutaway view of a conduit filled with molten glass of varying temperature; and

FIG. 7 is a schematic perspective cutaway view of a conduit filled with molten glass of varying temperature in accordance with embodiments disclosed herein.

### DETAILED DESCRIPTION

Reference will now be made in detail to the present preferred embodiments of the present disclosure, examples of which are illustrated in the accompanying drawings. Whenever possible, the same reference numerals will be used throughout the drawings to refer to the same or like parts. However, this disclosure may be embodied in many different forms and should not be construed as limited to the embodiments set forth herein.

Ranges can be expressed herein as from “about” one particular value, and/or to “about” another particular value. When such a range is expressed, another embodiment includes from the one particular value and/or to the other particular value. Similarly, when values are expressed as approximations, for example by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

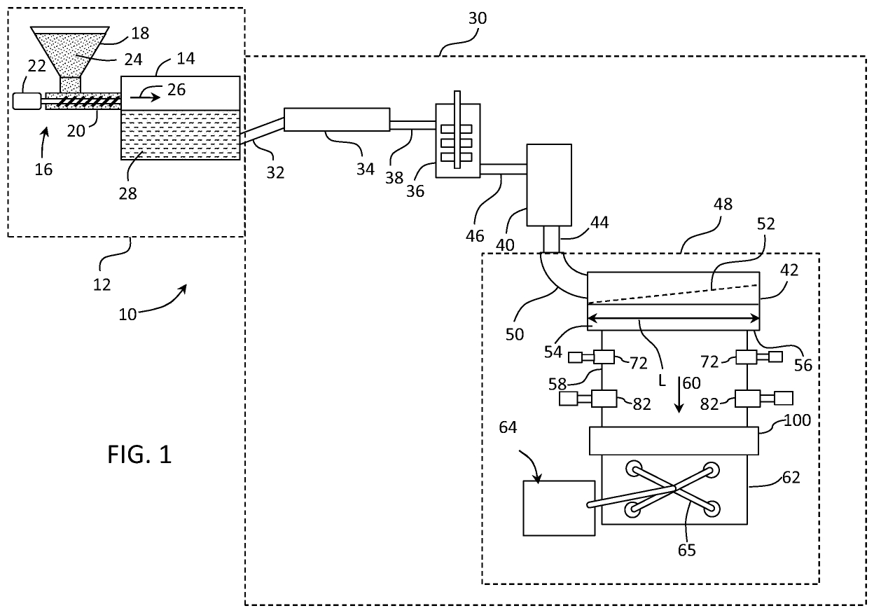

Shown in FIG. 1 is an exemplary glass manufacturing apparatus 10. In some examples, the glass manufacturing apparatus 10 can comprise a glass melting furnace 12 that can include a melting vessel 14. In addition to melting vessel 14, glass melting furnace 12 can optionally include one or more additional components such as heating elements (e.g., combustion burners or electrodes) that heat raw materials and convert the raw materials into molten glass. In further examples, glass melting furnace 12 may include thermal management devices (e.g., insulation components) that reduce heat lost from a vicinity of the melting vessel. In still further examples, glass melting furnace 12 may include electronic devices and/or electromechanical devices that facilitate melting of the raw materials into a glass melt. Still further, glass melting furnace 12 may include support structures (e.g., support chassis, support member, etc.) or other components.

Glass melting vessel 14 is typically comprised of refractory material, such as a refractory ceramic material, for example a refractory ceramic material comprising alumina or zirconia. In some examples glass melting vessel 14 may be constructed from refractory ceramic bricks. Specific embodiments of glass melting vessel 14 will be described in more detail below.

In some examples, the glass melting furnace may be incorporated as a component of a glass manufacturing apparatus to fabricate a glass substrate, for example a glass ribbon of a continuous length. In some examples, the glass melting furnace of the disclosure may be incorporated as a component of a glass manufacturing apparatus comprising a slot draw apparatus, a float bath apparatus, a down-draw apparatus such as a fusion process, an up-draw apparatus, a press-rolling apparatus, a tube drawing apparatus or any other glass manufacturing apparatus that would benefit from the aspects disclosed herein. By way of example, FIG. 1 schematically illustrates glass melting furnace 12 as a component of a fusion down-draw glass manufacturing apparatus 10 for fusion drawing a glass ribbon for subsequent processing into individual glass sheets.

The glass manufacturing apparatus 10 (e.g., fusion down-draw apparatus 10) can optionally include an upstream glass manufacturing apparatus 16 that is positioned upstream relative to glass melting vessel 14. In some examples, a portion of, or the entire upstream glass manufacturing apparatus 16, may be incorporated as part of the glass melting furnace 12.

As shown in the illustrated example, the upstream glass manufacturing apparatus 16 can include a storage bin 18, a raw material delivery device 20 and a motor 22 connected to the raw material delivery device. Storage bin 18 may be configured to store a quantity of raw materials 24 that can be fed into melting vessel 14 of glass melting furnace 12, as indicated by arrow 26. Raw materials 24 typically comprise one or more glass forming metal oxides and one or more modifying agents. In some examples, raw material delivery device 20 can be powered by motor 22 such that raw material delivery device 20 delivers a predetermined amount of raw materials 24 from the storage bin 18 to melting vessel 14. In further examples, motor 22 can power raw material delivery device 20 to introduce raw materials 24 at a controlled rate based on a level of molten glass sensed downstream from melting vessel 14. Raw materials 24 within melting vessel 14 can thereafter be heated to form molten glass 28.

Glass manufacturing apparatus 10 can also optionally include a downstream glass manufacturing apparatus 30 positioned downstream relative to glass melting furnace 12. In some examples, a portion of downstream glass manufacturing apparatus 30 may be incorporated as part of glass melting furnace 12. In some instances, first connecting conduit 32 discussed below, or other portions of the downstream glass manufacturing apparatus 30, may be incorporated as part of glass melting furnace 12. Elements of the downstream glass manufacturing apparatus, including first connecting conduit 32, may be formed from a precious metal. Suitable precious metals include platinum group metals selected from the group of metals consisting of platinum, iridium, rhodium, osmium, ruthenium and palladium, or alloys thereof. For example, downstream components of the glass manufacturing apparatus may be formed from a platinum-rhodium alloy including from about 70 to about 90% by weight platinum and about 10% to about 30% by weight rhodium. However, other suitable metals can include molybdenum, palladium, rhenium, tantalum, titanium, tungsten and alloys thereof.

Downstream glass manufacturing apparatus 30 can include a first conditioning (i.e., processing) vessel, such as fining vessel 34, located downstream from melting vessel 14 and coupled to melting vessel 14 by way of the above-referenced first connecting conduit 32. In some examples, molten glass 28 may be gravity fed from melting vessel 14 to fining vessel 34 by way of first connecting conduit 32. For instance, gravity may cause molten glass 28 to pass through an interior pathway of first connecting conduit 32 from melting vessel 14 to fining vessel 34. It should be understood, however, that other conditioning vessels may be positioned downstream of melting vessel 14, for example between melting vessel 14 and fining vessel 34. In some embodiments, a conditioning vessel may be employed between the melting vessel and the fining vessel wherein molten glass from a primary melting vessel is further heated to continue the melting process, or cooled to a temperature lower than the temperature of the molten glass in the melting vessel before entering the fining vessel.

Bubbles may be removed from molten glass 28 within fining vessel 34 by various techniques. For example, raw materials 24 may include multivalent compounds (i.e. fining agents) such as tin oxide that, when heated, undergo a chemical reduction reaction and release oxygen. Other suitable fining agents include without limitation arsenic, antimony, iron and cerium. Fining vessel 34 is heated to a temperature greater than the melting vessel temperature, thereby heating the molten glass and the fining agent. Oxygen bubbles produced by the temperature-induced chemical reduction of the fining agent(s) rise through the molten glass within the fining vessel, wherein gases in the molten glass produced in the melting furnace can diffuse or coalesce into the oxygen bubbles produced by the fining agent. The enlarged gas bubbles can then rise to a free surface of the molten glass in the fining vessel and thereafter be vented out of the fining vessel. The oxygen bubbles can further induce mechanical mixing of the molten glass in the fining vessel.

Downstream glass manufacturing apparatus 30 can further include another conditioning vessel such as a mixing vessel 36 for mixing the molten glass. Mixing vessel 36 may be located downstream from the fining vessel 34. Mixing vessel 36 can be used to provide a homogenous glass melt composition, thereby reducing cords of chemical or thermal inhomogeneity that may otherwise exist within the fined molten glass exiting the fining vessel. As shown, fining vessel 34 may be coupled to mixing vessel 36 by way of a second connecting conduit 38. In some examples, molten glass 28 may be gravity fed from the fining vessel 34 to mixing vessel 36 by way of second connecting conduit 38. For instance, gravity may cause molten glass 28 to pass through an interior pathway of second connecting conduit 38 from fining vessel 34 to mixing vessel 36. It should be noted that while mixing vessel 36 is shown downstream of fining vessel 34, mixing vessel 36 may be positioned upstream from fining vessel 34. In some embodiments, downstream glass manufacturing apparatus 30 may include multiple mixing vessels, for example a mixing vessel upstream from fining vessel 34 and a mixing vessel downstream from fining vessel 34. These multiple mixing vessels may be of the same design, or they may be of different designs.

Downstream glass manufacturing apparatus 30 can further include another conditioning vessel such as delivery vessel 40 that may be located downstream from mixing vessel 36. Delivery vessel 40 may condition molten glass 28 to be fed into a downstream forming device. For instance, delivery vessel 40 can act as an accumulator and/or flow controller to adjust and/or provide a consistent flow of molten glass 28 to forming body 42 by way of exit conduit 44. As shown, mixing vessel 36 may be coupled to delivery vessel 40 by way of third connecting conduit 46. In some examples, molten glass 28 may be gravity fed from mixing vessel 36 to delivery vessel 40 by way of third connecting conduit 46. For instance, gravity may drive molten glass 28 through an interior pathway of third connecting conduit 46 from mixing vessel 36 to delivery vessel 40.

Downstream glass manufacturing apparatus 30 can further include forming apparatus 48 comprising the above-referenced forming body 42 and inlet conduit 50. Exit conduit 44 can be positioned to deliver molten glass 28 from delivery vessel 40 to inlet conduit 50 of forming apparatus 48. For example in examples, exit conduit 44 may be nested within and spaced apart from an inner surface of inlet conduit 50, thereby providing a free surface of molten glass positioned between the outer surface of exit conduit 44 and the inner surface of inlet conduit 50. Forming body 42 in a fusion down draw glass making apparatus can comprise a trough 52 positioned in an upper surface of the forming body and converging forming surfaces 54 that converge in a draw direction along a bottom edge 56 of the forming body. Molten glass delivered to the forming body trough via delivery vessel 40, exit conduit 44 and inlet conduit 50 overflows side walls of the trough and descends along the converging forming surfaces 54 as separate flows of molten glass. The separate flows of molten glass join below and along bottom edge 56 to produce a single ribbon of glass 58 that is drawn in a draw or flow direction 60 from bottom edge 56 by applying tension to the glass ribbon, such as by gravity, edge rolls 72 and pulling rolls 82, to control the dimensions of the glass ribbon as the glass cools and a viscosity of the glass increases. Accordingly, glass ribbon 58 goes through a visco-elastic transition and acquires mechanical properties that give the glass ribbon 58 stable dimensional characteristics. Glass ribbon 58 may, in some embodiments, be separated into individual glass sheets 62 by a glass separation apparatus 100 in an elastic region of the glass ribbon. A robot 64 may then transfer the individual glass sheets 62 to a conveyor system using gripping tool 65, whereupon the individual glass sheets may be further processed.

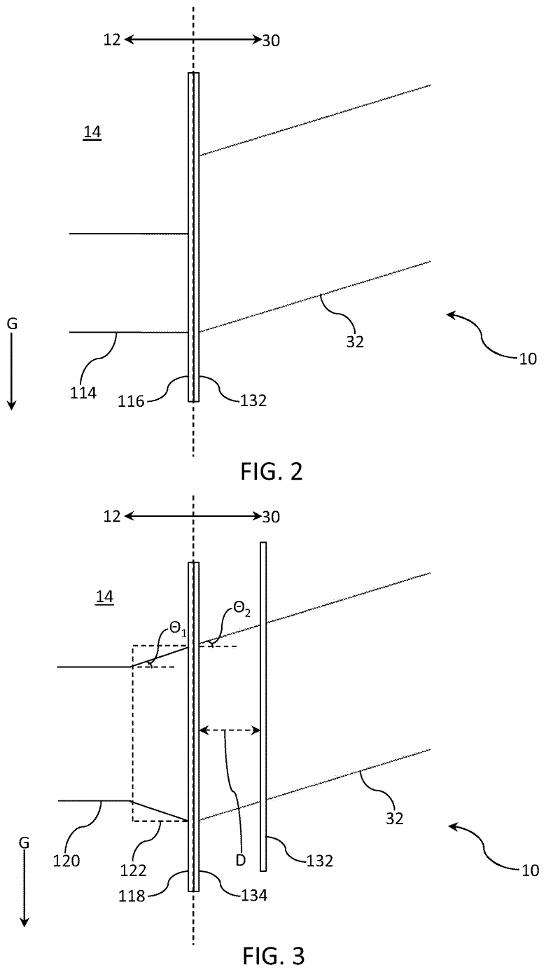

FIG. 2 shows a schematic perspective side view of a portion of a glass manufacturing apparatus 10 including a conduit 32, which is the same as first connecting conduit 32 shown in FIG. 1. Connecting conduit 32 extends within downstream glass manufacturing apparatus 30 and is in fluid communication with a glass melting vessel 14 of a glass melting furnace 12. Specifically, connecting conduit 32 is in fluid communication with a melting furnace conduit 114 that extends within melting vessel 14 of glass melting furnace 12. An annular heating element 132 circumferentially surrounds connecting conduit 32 at the interface of glass melting furnace 12 and connecting conduit 32, which is coupled with an annular sealing element 116, which circumferentially surrounds melting furnace conduit 114 at the interface of glass melting furnace 12 and connecting conduit 32. The coupling of annular heating element 132 with annular sealing element 116 acts to mitigate or prevent leakage of molten glass 28 between glass melting furnace 12 and downstream glass manufacturing apparatus 30. In addition, annular heating element 132 heats molten glass 28 in connecting conduit 32.

FIG. 3 is a schematic perspective side view of a portion of a glass manufacturing apparatus 10 including a conduit 32 in accordance with embodiments disclosed herein. Connecting conduit 32 is the same as first connecting conduit 32 shown in FIG. 1. Connecting conduit 32 extends within downstream glass manufacturing apparatus 30 and is in fluid communication with a glass melting vessel 14 of a glass melting furnace 12. Specifically, connecting conduit 32 is in fluid communication with a melting furnace conduit 120 that extends within melting vessel 14 of glass melting furnace 12. A first annular sealing element 134 circumferentially surrounds connecting conduit 32 at the interface of glass melting furnace 12 and connecting conduit 32. First annular sealing element 134 is coupled with second annular sealing element 118, which circumferentially surrounds melting furnace conduit 120 at the interface of glass melting furnace 12 and connecting conduit 32. In addition, an annular heating element 132 circumferentially surrounds connecting conduit 32 and is separated from the first annular sealing element 134 by a predetermined distance (shown by double arrow ‘D’ in FIG. 3) along an axial length of connecting conduit 32. The coupling of first annular heating element 134 with second annular sealing element 118 acts to mitigate or prevent leakage of molten glass 28 between glass melting furnace 12 and downstream glass manufacturing apparatus 30. In addition, annular heating element 132 heats molten glass 28 in connecting conduit 32.

As shown in FIG. 3, melting furnace conduit 120 includes a flared region 122 that includes an outer circumference that increases along its axial length in a direction toward the interface of the glass melting furnace 12 and the connecting conduit 32. As additionally shown in FIG. 3, the outer circumference of melting furnace conduit 120 is the same as the outer circumference of connecting conduit 32 at the interface of the glass melting furnace 12 and the connecting conduit 32.

In certain exemplary embodiments, flared region 122 has a cross section that increases in a direction toward the interface of the glass melting furnace 12 and the connecting conduit 32 such that its uppermost longitudinally extending surface inclines relative to a reference plane perpendicular to a direction of gravity (shown by arrow ‘G’ in FIG. 3) at an angle Θ₁ and connecting conduit 32 also has an uppermost longitudinally extending surface that inclines relative to a reference plane perpendicular to a direction of graving at an angle Θ₂. In certain exemplary embodiments, each of Θ₁ and Θ₂ range from about 10 degrees to about 40 degrees, such as from about 20 degrees to about 30 degrees. In certain exemplary embodiments Θ₁ is within about 10 degrees of Θ₂, such as within about 5 degrees of Θ₂, and further such as within about 2 degrees of Θ₂, including substantially the same as Θ₂ and including within about 10 degrees to about 0 degrees of Θ₂, and further including within about 5 degrees to about 1 degree of Θ₂.

In certain exemplary embodiments, predetermined distance ‘D’ ranges from about 1 centimeter to about 10 centimeters, such as from about 2 centimeters to about 6 centimeters, including from about 3 centimeters to about 5 centimeters.

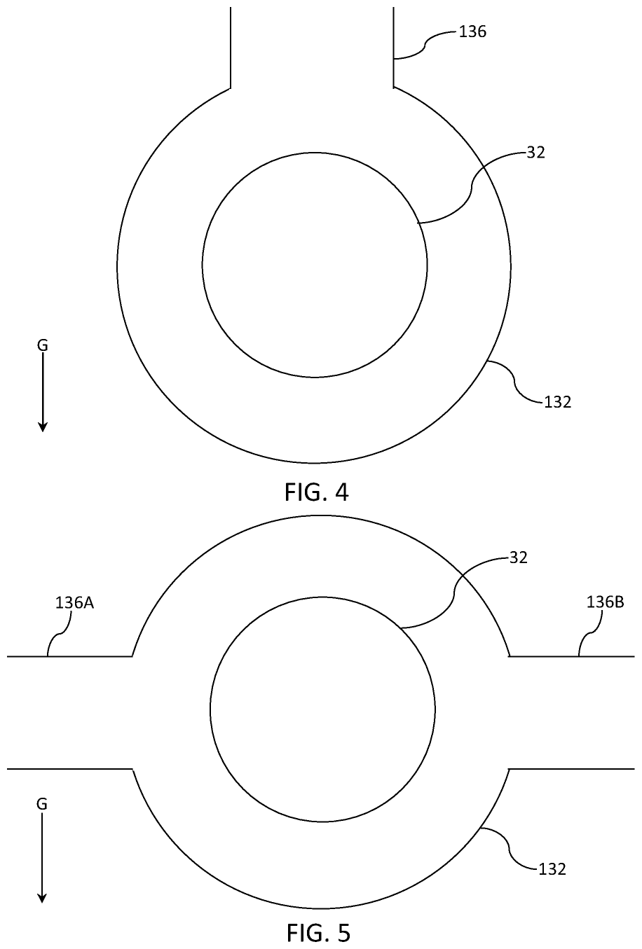

FIG. 4 shows a schematic perspective cutaway view of an annular heating element 132 circumferentially surrounding a portion of a conduit 32. Specifically, FIG. 4 shows annular heating element 132 of FIG. 2 circumferentially surrounding a portion of connecting conduit 32 (which is the same as first connecting conduit 32 shown in FIG. 1). Annular heating element 132 is coupled with power input 136, which directs power from a power source (not shown) to annular heating element 132 in a direction that is parallel to a direction of gravity (shown as arrow ‘G’in FIG. 4).

FIG. 5 shows a schematic perspective cutaway view of an annular heating element 132 circumferentially surrounding a portion of a conduit 32 in accordance with embodiments disclosed herein. Specifically, FIG. 5 shows annular heating element 132 of FIG. 3 circumferentially surrounding a portion of connecting conduit 32 (which is the same as first connecting conduit 32 shown in FIG. 1). Annular heating element 132 is coupled with two power inputs, specifically a first power input 136A and a second power input 136B, that are spaced apart at a predetermined distance with respect to an outer circumference of annular heating element 132. Specifically, first power input 136A and second power input 136B are coupled with annular heating element 132 at opposing positions with respect to an outer circumference of annular heating element 132 (i.e., at the 3 o'clock and 9 o'clock positions), wherein each of first power input 136A and second power input 136B direct power to annular heating element 132 in a direction that is perpendicular to a direction of gravity (shown as arrow ‘G’ in FIG. 5). And while FIG. 5 shows coupling of annular heating element 132 with two power inputs, embodiments disclosed herein include those in which annular heating element is coupled with additional power inputs (not shown). In addition, while connecting conduit 32 is shown in FIG. 5 as having a circular cross section, embodiments disclosed herein include those in which connecting conduit 32 has other cross sections including, but not limited to, elliptical or polygonal cross sections.

Power inputs 136A and 136B may be connected to a power source (not shown), such as an electrical power source, as known to persons having ordinary skill in the art. This can, in turn, cause resistive heating of annular heating element 132, which can, in turn, heat conduit 32 as well as molten glass 28 flowing through conduit 32 to a desired temperature.

In certain exemplary embodiments, annular heating element 132 comprises a metal or metal alloy comprising at least one of nickel, copper, palladium, or platinum.

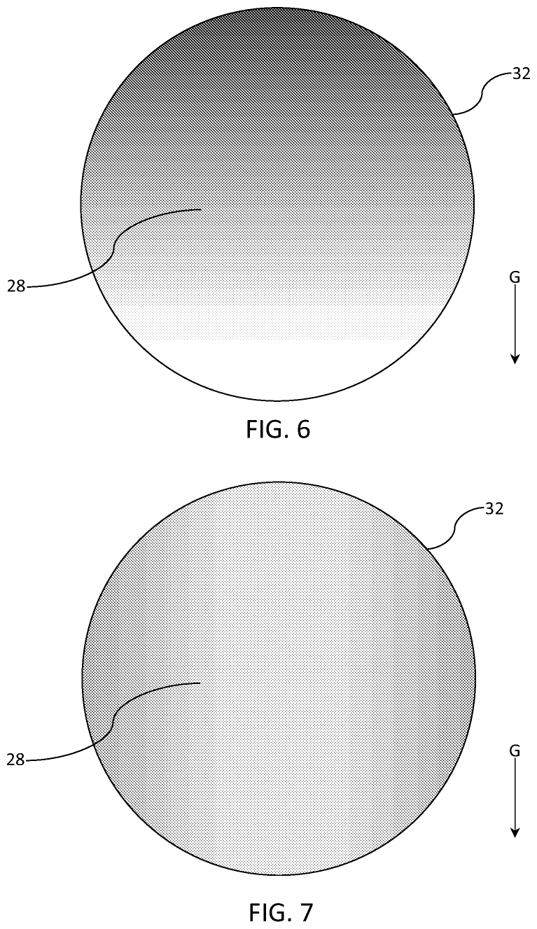

FIG. 6 shows a schematic perspective cutaway view of a conduit 32 filled with molten glass 28 of varying temperature. Specifically, FIG. 6 shows a cross-section of conduit 32 of FIG. 2 proximate to annular heating element 132 of FIG. 4, wherein relatively hotter molten glass 28 is shown in relatively darker shading and relatively colder molten glass 28 is shown in relatively lighter shading. As can be seen in FIG. 6, molten glass 28 temperature decreases in direction parallel to a direction of gravity (shown as arrow ‘G’ in FIG. 6), wherein highest region within conduit is the hottest and lowest region with conduit is the coldest.

FIG. 7 shows a schematic perspective cutaway view of a conduit 32 filled with molten glass 28 of varying temperature in accordance with embodiments disclosed herein. Specifically, FIG. 7 shows a cross-section of conduit 32 of FIG. 3 proximate to annular heating element 132 of FIG. 5, wherein relatively hotter molten glass 28 is shown in relatively darker shading and relatively colder molten glass 28 is shown in relatively lighter shading. As can be seen in FIG. 7, molten glass 28 temperature decreases in a direction perpendicular to gravity (shown as arrow ‘G’ in FIG. 7), wherein far left and far right regions within conduit are the hottest.

As can be seen by comparing FIGS. 6 and 7, molten glass 28 temperature in hottest region of conduit 32 of FIG. 6 is higher than the molten glass 28 temperature in hottest regions of conduit 32 of FIG. 7. Conversely, molten glass 28 temperature in coldest region of conduit 32 of FIG. 6 is lower than the molten glass 28 temperature in the coldest regions of conduit 32 of FIG. 7, such that the temperature differential (i.e., difference between highest and lowest temperatures) of molten glass 28 in FIG. 6 is greater than the temperature differential of molten glass 28 in FIG. 7.

Maintaining a more even cross-sectional molten glass 28 temperature distribution within conduit 32, such as is shown in FIG. 7, results in heating molten glass 28 to within a desired average molten glass 28 temperature range while preventing the hottest region of the molten glass 28 from being above a desired temperature. For example, the hottest region of molten glass 28 within conduit 32 is typically proximate to annular heating element 132 and if this region becomes too hot, such condition may, for example, result in several undesirable consequences including, but not limited to, oxidative corrosion of conduit 32 and/or annular heating element 132, which can, in turn, lead to deformation of heating element 132 and/or leakage of molten glass 28 from conduit 32. Such condition may also lead to molten glass 28 contamination via introduction of conduit 32 and/or heating element 132 oxidation reaction products into molten glass 28.

Embodiments disclosed herein can mitigate or prevent such condition by, for example, spacing heating element 132 a predetermined distance from first annular sealing element 134 along an axial length of conduit 32, coupling annular heating element 132 with at least two power inputs spaced apart at a predetermined distance with respect to an outer circumference of the annular heating element, and/or including a flared region 122 in melting furnace conduit 120 that increases along its axial length in a direction toward the interface of the glass melting furnace 12 and the connecting conduit 32. In this regard, the combination of these features can provide a synergistic effect in heating molten glass 28 to within a desired average molten glass 28 temperature range while preventing the hottest region of the molten glass 28 from being above a desired temperature. In addition, spacing between first annular sealing element 134 and annular heating element 132 mitigates or prevents the simultaneous failure of sealing and heating functionality.

While the above embodiments have been described with reference to a fusion down draw process, it is to be understood that such embodiments are also applicable to other glass forming processes, such as float processes, slot draw processes, up-draw processes, tube drawing processes, and press-rolling processes.

It will be apparent to those skilled in the art that various modifications and variations can be made to embodiment of the present disclosure without departing from the spirit and scope of the disclosure. Thus it is intended that the present disclosure cover such modifications and variations provided they come within the scope of the appended claims and their equivalents.

1. An apparatus for manufacturing a glass article comprising:
a glass melting furnace in fluid communication with a connecting conduit;
a first annular sealing element circumferentially surrounding the connecting conduit at an interface of the glass melting furnace and the connecting conduit; and
an annular heating element circumferentially surrounding the connecting conduit and separated from the first annular sealing element by a predetermined distance along an axial length of the connecting conduit.

2. The apparatus of claim 1, wherein the apparatus comprises a melting furnace conduit extending within the melting furnace and in fluid communication with the connecting conduit.

3. The apparatus of claim 2, wherein a second annular sealing element circumferentially surrounds the melting furnace conduit at the interface of the glass melting furnace and the connecting conduit.

4. The apparatus of claim 3, wherein the melting furnace conduit comprises a flared region comprising an outer circumference that increases along its axial length in a direction toward the interface of the glass melting furnace and the connecting conduit.

5. The apparatus of claim 4, wherein the outer circumference of the melting furnace conduit is the same as an outer circumference of the connecting conduit at the interface of the glass melting furnace and the connecting conduit.

6. The apparatus of claim 1, wherein the annular heating element is coupled with at least two power inputs spaced apart at a predetermined distance with respect to an outer circumference of the annular heating element.

7. The apparatus of claim 6, wherein a first and second of the at least two power inputs are coupled with the annular heating element at opposing positions with respect to an outer circumference of the annular heating element.

8. The apparatus of claim 7, wherein the first and second of the at least two power inputs each direct power to the annular heating element in a direction that is perpendicular to a direction of gravity.

9. The apparatus of claim 1, wherein the predetermined distance ranges from about 1 centimeter to about 10 centimeters.

10. The apparatus of claim 1, wherein the annular heating element comprises a metal or metal alloy comprising at least one of nickel, copper, palladium, or platinum.

11. A method of manufacturing a glass article comprising:
flowing molten glass from a glass melting furnace to a connecting conduit, wherein a first annular sealing element circumferentially surrounds the connecting conduit at an interface of the glass melting furnace and the connecting conduit; and
heating the connecting conduit with an annular heating element circumferentially surrounding the connecting conduit and separated from the first annular sealing element by a predetermined distance along an axial length of the connecting conduit.

12. The method of claim 11, wherein the apparatus comprises a melting furnace conduit extending within the melting furnace and in fluid communication with the connecting conduit.

13. The method of claim 12, wherein a second annular sealing element circumferentially surrounds the melting furnace conduit at the interface of the glass melting furnace and the connecting conduit.

14. The method of claim 13, wherein the melting furnace conduit comprises a flared region comprising an outer circumference that increases along its axial length in a direction toward the interface of the glass melting furnace and the connecting conduit.

15. The method of claim 14, wherein the outer circumference of the melting furnace conduit is the same as an outer circumference of the connecting conduit at the interface of the glass melting furnace and the connecting conduit.

16. The method of claim 11, wherein the annular heating element is coupled with at least two power inputs spaced apart at a predetermined distance with respect to an outer circumference of the annular heating element.

17. The method of claim 16, wherein a first and second of the at least two power inputs are coupled with the annular heating element at opposing positions with respect to an outer circumference of the annular heating element.

18. The method of claim 17, wherein the first and second of the at least two power inputs each direct power to the annular heating element in a direction that is perpendicular to a direction of gravity.

19. The method of claim 11, wherein the predetermined distance ranges from about 1 centimeter to about 10 centimeters.

20. The method of claim 11, wherein the annular heating element comprises a metal or metal alloy comprising at least one of nickel, copper, palladium, or platinum.

21. A glass article made by the method of any of claim 11.

22. An electronic device comprising the glass article of claim 21.
